(19) United States
(12) Patent Application Publication
(10) Pub. No.: US 2009/0231264 A1
(43) Pub. Date: Sep. 17, 2009

(54) IMAGE DISPLAY APARATUS

(76) Inventors: Atsushi Hatakeyama, Osaka (JP); Shinji Fujita, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/402,831

(22) Filed: Mar. 12, 2009

(30) Foreign Application Priority Data
Mar. 13, 2008 (JP) 2008-063665
Mar. 3, 2009 (JP) 2009-049343

(51) Int. Cl. G09G 3/36

(52) U.S. Cl. 345/102

(57) ABSTRACT

An image display apparatus including a liquid crystal display unit having a display surface and rear surface facing a display surface, a light conducting plate having a front surface, a bottom surface facing the front surface, and a side end surface perpendicular to the front surface and the bottom surface, the light conducting plate being arranged to face the rear surface of the liquid crystal display unit, the front surface of the light conducting plate facing the rear surface of the liquid crystal display unit, wherein the light conducting plate has a reflective sheet on the bottom surface, wherein incident light from a side end surface of the plate is reflected on the reflective sheet on the bottom surface so as to be conducted toward the front surface, and an LED element that has a light emitting surface facing the side end surface of the light conducting plate, for radiating light from the light emitting surface to the side end surface, wherein the LED element is arranged in the manner that the central axis of the light emitting surface of the LED element is shifted onto either of the bottom surface side or the front surface side of the light conducting plate from the middle surface of the light conducting plate between the front surface and the bottom surface of the light conducting plate.

### BACKGROUND OF THE INVENTION

The present application claims the priority of Japanese Patent Application No. 2008-63665 filed on Mar. 13, 2008 in Japan, and that of Japanese Patent Application No. 2009-49343 filed on Mar. 3, 2009 in Japan, and the contents of which are incorporated herein by reference.

### TECHNICAL FIELD OF THE INVENTION

The present invention relates to an image display apparatus having a backlight source, in particular, an image display apparatus having an LED element as its backlight source.

### DESCRIPTION OF THE PRIOR ART

In the main current of image display apparatuses in recent years, liquid crystal has been used. In the apparatuses, images are displayed by transmitting light radiated into their liquid crystal panel from a backlight arranged on the rear surface side of the panel, wherein TFTs are formed on a glass piece and a liquid crystal is confined. Therefore, in order to obtain a bright and beautiful high-quality image, it is essential that the backlight is bright and is further even on the surface.

Hitherto, a cold cathode tube has been used as a light source for the backlight of image display apparatuses wherein such a liquid crystal panel is used. However, with a technical progress in recent years, a remarkable improvement has been made in the efficiency and the brightness of LED elements so that the elements have come to give efficiency and brightness approximately equal to those of cold cathode tubes. For this reason, the use of LED elements has been spreading as the backlight source of small-sized liquid crystal display apparatuses.

However, LED elements emit light in a point form while cold cathode tubes emit light in a linear form. Therefore, in the case of using an LED element as a backlight source, it is necessary for gaining an illuminance approximately equal to that of cold cathode tubes that a large number of LED elements giving a low power are used or a high-power LED element is used to disperse light rays efficiently.

A large number of such examples, wherein LED elements as point light sources are used as a backlight source, are disclosed. In particular, the luminous intensity distribution in a light emitting surface is made even, as shown in Japanese Patent Laid-open Publication No. 2005-79038. Further, heat generated from LED elements are radiated to restrain a rise in the temperature, as shown in Japanese Patent Laid-open Publication No. 2006-216244, and others.

### SUMMARY OF THE INVENTION

However, in recent years, LED elements as light sources have been becoming smaller and the power thereof has been becoming higher. For information processing machines or the like using these image display apparatuses, the size thereof has also been becoming small, or the form thereof has been turning in a portable form. Thus, the following have been required: impact resistance and vibration resistance when the machines are used outdoors or the like; an extension of the dynamic range of the brightness for making the machines usable in both of indoors and the outdoors; and others.

In order to keep the impact resistance and the vibration resistance certainly, it is required to make a light conducting plate which constitutes a backlight source unit as thick as in the prior art to make the rigidity high, or use a basic structure of a backlight source unit using the present cold cathode tube. However, if a small-sized LED element is formed in such a manner that its LED element substrate is stepped in order to make the central axis of the LED element consistent with the middle surface of its light conducting plate, a problem that radiation of heat is blocked by the stepped region, and other problems are caused.

Thus, an object of the present invention is to solve such problems and provide a long-lifespan image display apparatus that gives an adjustable brightness, realizes a high brightness, and exhibits an even luminous intensity distribution.

To achieve the above object, an image display apparatus according to the present invention, includes:

a liquid crystal display unit having a display surface and rear surface facing a display surface;

a light conducting plate having a front surface, a bottom surface facing the front surface, and a side end surface perpendicular to the front surface and the bottom surface, the light conducting plate being arranged to face the rear surface of the liquid crystal display unit, the front surface of the light conducting plate facing the rear surface of the liquid crystal display unit, wherein the light conducting plate has a reflective sheet on the bottom surface, wherein incident light from a side end surface of the light conducting plate is reflected on the reflective sheet on the bottom surface so as to be conducted toward the front surface; and

an LED element that has a light emitting surface facing the side end surface of the light conducting plate, for radiating light from the light emitting surface to the side end surface,

wherein the LED element is arranged in the manner that the central axis of the light emitting surface of the LED element is shifted onto either of the bottom surface side or the front surface side of the light conducting plate from the middle surface of the light conducting plate between the front surface and the bottom surface of the light conducting plate.

According to this structure, an image display apparatus can be realized wherein a light conducting plate that is large in thickness so as to have rigidity is used to give impact resistance and vibration resistance.

In addition, the LED element may be arranged relatively to a plane including the middle surface of the light conducting plate between the front surface and the bottom surface of the light conducting plate in the manner that both end portions of the light emitting surface of the LED element in the thickness direction of the light conducting plate are included into the bottom surface side of the light conducting plate.

According to this structure, the distance between the central axis of light-radiation of the LED element and the reflective sheet is short, so that in an end portion of the light conducting plate, the interval between the following can be made short: light reflected on the reflective sheet and then radiated out from the light conducting plate, and light transmitted through the light conducting plate. Thus, the length of the end region of the light conducting plate for causing light to be evenly radiated into the liquid crystal panel region can be made small. Therefore, the frame (or trim) region of the image display apparatus is made small so that the whole of the image display apparatus can be made small.

Moreover, the LED element may be arranged relatively to a plane including the middle surface of the light conducting plate between the front surface and the bottom surface of the light conducting plate in the manner that both end portions of the light emitting surface of the LED element in the thickness direction of the light conducting plate are included into the front surface side of the light conducting plate.

In addition, the LED element may include:

one or more upper LED elements arranged relatively to a plane including the middle surface of the light conducting plate between the front surface and the bottom surface of the light conducting plate in the manner that both end portions of the light emitting surface of the LED element(s) in the thickness direction of the light conducting plate are included into the front surface side of the light conducting plate, and

one or more lower LED elements arranged relatively to a plane including the middle surface of the light conducting plate between the front surface and the bottom surface of the light conducting plate in the manner that both the end portions of the light emitting surface of the LED element(s) in the thickness direction of the light conducting plate are included into the bottom surface side of the light conducting plate.

According to this structure, a large number of LED elements can be arranged. The control of an input to each of the LED elements makes it possible to provide an image display apparatus wherein brightness can be adjusted and a high brightness is realized.

The upper LED elements and the lower LED elements may alternately be arranged when the LEDs are viewed from the thickness direction of the light conducting plate.

According to this structure, a bright and dark phenomenon is cancelled, which is a phenomenon based on overlap of light rays which is generated in the end portion by light emitted from individual LED elements of the upper LED elements and the lower LED elements. As a result, an image display apparatus giving an even luminous intensity distribution can be realized.

The image display apparatus may further includes a heat-radiating plate having an opening region wherein an opening is made toward the side end surface of the light conducting plate. In this case, the upper and lower LEDs are preferably arranged in the opening region of the heat-radiating plate.

According to this structure, heat generated from individual LED elements of the upper and lower LED elements can be effectively radiated so that an input to each of the LED elements can easily be controlled.

The light conducting plate may contain forward-scattering particles arranged to be dispersed.

In addition, a prism sheet is laid between the light conducting plate and the front surface side facing the rear surface of the liquid crystal display unit.

As described above, according to the image display apparatus of the present invention, realized is an image display apparatus that gives an adjustable brightness, realizes a high brightness, exhibits an even luminous intensity distribution, has impact resistance, and is suitable for a portable form.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a schematic perspective view illustrating the structure of an image display apparatus according to a first embodiment;

FIG. 2 is a partial sectional view taken along line A-A in FIG. 1;

FIG. 3 is a schematic sectional view illustrating the arrangement of an LED element of a backlight source unit of the image display apparatus according to the first embodiment relative to its light conducting plate;

FIG. 4A is a schematic sectional view illustrating the optical path of light radiated from the LED element into the light conducting plate when the central axis of the light emitting surface of the LED element is made consistent with the middle surface of the light conducting plate. FIG. 4B is a schematic sectional view illustrating the optical path of light radiated from the LED element into the light conducting plate when the central axis of the light emitting surface of the LED element is shifted from the middle surface of the light conducting plate to the bottom surface side thereof. FIG. 4C is a schematic sectional view illustrating the optical path of light radiated from the LED element into the light conducting plate when the central axis of the light emitting surface of the LED element is shifted from the middle surface of the light conducting plate to the front surface side thereof;

FIG. 5 is a schematic sectional view illustrating the structure of an end portion of an image display apparatus according to a second embodiment;

FIG. 6 is a schematic sectional view illustrating the structure of an end portion of an image display apparatus according to a third embodiment; and

FIG. 7A is a schematic plan view illustrating the arrangement of LED elements of a backlight source unit of an image display apparatus according to an fourth embodiment, and FIG. 7B is a schematic plan view of LED elements in a case where the LED elements are arranged on a line in the same plane;

### PREFERRED EMBODIMENT OF THE INVENTION

With reference to the attached drawings, image display apparatuses according to embodiments will be described hereinafter. In the drawings, the same reference numerals are attached to substantially the same members.

### First Embodiment

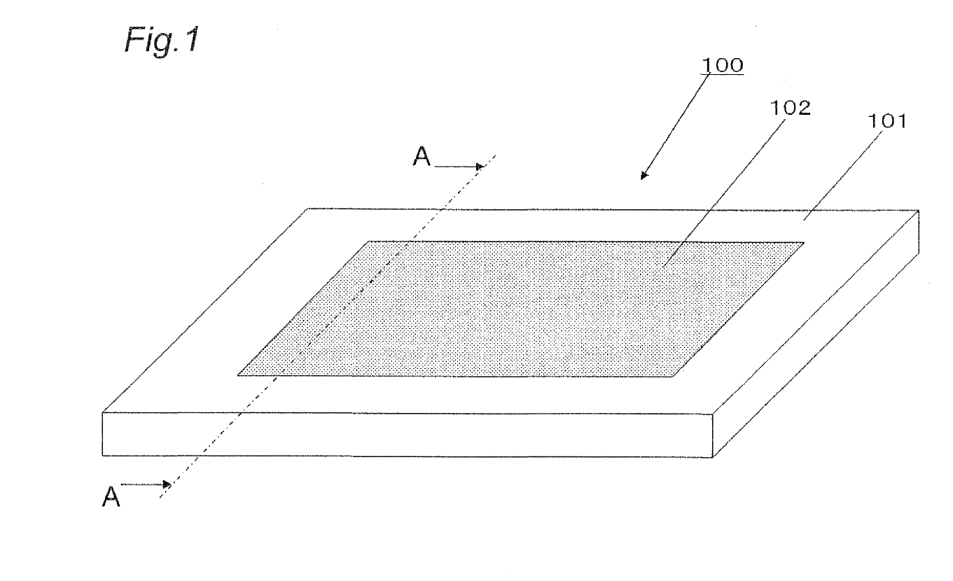

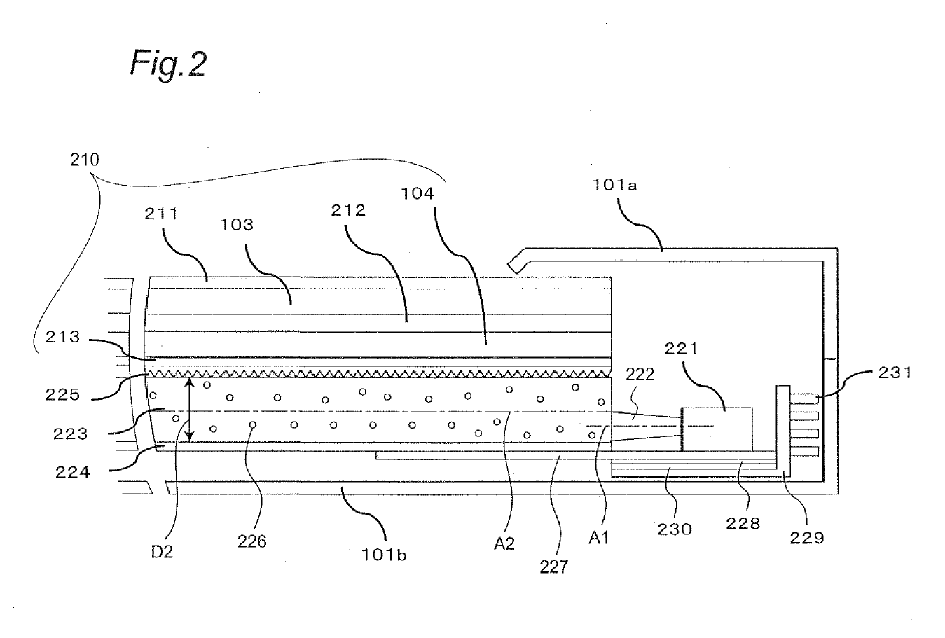

FIG. 1 is a perspective view that schematically illustrates an image display apparatus according to a first embodiment, and FIG. 2 is a partial sectional view taken along line A-A of FIG. 1. As illustrated in FIG. 1, in an image display apparatus 100, which is the apparatus, the periphery thereof is surrounded by a housing 101 made of resin, and a liquid crystal panel 102 is arranged therein. As illustrated in FIG. 2, the liquid crystal panel 102 is made up of a liquid crystal display unit and a backlight source unit. The liquid crystal display unit is equipped with a front surface glass substrate 103, a rear surface glass substrate 104, a liquid crystal body region 212 arranged between the front and rear surface glass substrates 103 and 104, a light-ejection-side polarizing plate 211 disposed on the front surface glass substrate 103, and a light-incident-side polarizing plate 213 disposed on the rear surface glass substrate 104. Furthermore, the backlight source unit is made up of a light conducting plate 223 arranged on the rear surface of the liquid crystal display unit, and an LED element 221 arranged on a single side-end portion of the liquid crystal display unit in the short-side direction thereof, which is source for radiating light to side end surface of the light conducting plate 223. The light conducting plate 223 conducts a white light ray 222 emitted from the LED element 221 to the liquid crystal display unit 210 on the front side. The light conducting plate 223 is equipped with a reflective sheet 224 arranged on the rear surface, and a prism sheet 225 arranged on the front surface of the light conducting plate 223. Forward-scattering particles 226 are arranged in the light conducting plate 223 so as to be dispersed.

First, the function of the light conducting plate 223 is described.

The white light ray 222 radiated out from the LED element 221 in the backlight source unit cannot make the liquid crystal display unit luminous evenly if the white light ray 222 is kept as it is. Thus, the white light ray 222 is conducted into a side end surface of the light conducting plate 223 and then reflected evenly on the surface of the reflective sheet 224 arranged on the bottom surface of the light conducting plate 223, so as to be turned into a light ray approximately perpendicular to the rear surface of the liquid crystal display unit by the prism sheet 225. The light ray is then radiated into the rear surface. The light ray radiated into the liquid crystal display unit is polarized by the light-incident-side polarizing plate 213, and made into a polarized light ray corresponding to the twist angle of the liquid crystal confined in the liquid crystal body region 212, so as to be radiated out. The radiated-out light ray is partially blocked by the light-ejection-side polarizing plate 211, so that the quantity of light emerging on the screen is varied. As a result, gradation is decided in every pixel. The thickness D2 of this light conducting plate 223 is preferably from about 0.6 to 3.5 mm, and is about 3 mm in this embodiment.

The following describes a detailed structure of the end region wherein the LED element 221 of the backlight source unit of the image display apparatus 100 is arranged. As illustrated in FIG. 2, in the first embodiment, the LED element 221 is jointed to an insulating plate 228 disposed on the same face where a substrate 227 for the reflective sheet 224 laid on the rear surface of the light conducting plate 223 is disposed. To the insulating plate 228 is connected a heat-radiating plate 229 made of a material good in thermal conductivity, for example, a metallic material such as aluminum or copper through a thermally-conductive double-sided adhesive agent 230 or the like. The heat-radiating plate 229 is worked into an L-shaped form or the like, and heat-radiating fins 231 are disposed in the surface thereof. Furthermore, the liquid crystal panel 102, the LED element 221, the heat-radiating plate 229 and so on are arranged in the housing 101, which is made up of a front surface side housing 101a and a bottom surface side housing 101b, whereby the image display apparatus 100 is constructed. The material of each of the members is not limited to the above-mentioned material, and may be an ordinarily usable material.

As illustrated in FIG. 2, the thickness of the LED element 221 is made smaller than the thickness D2 of the light conducting plate 223. For a light emitting surface B of the LED element 221, the length in the vertical direction (the thickness direction of the light conducting plate) is preferably from 0.5 to 3.0 mm, and the length in the transverse direction (the horizontal direction) is preferably from 1.5 to 4.0 mm. In this embodiment, as the LED element 221, the following is used: an element having a light emitting surface B having a length of 0.8 mm in the vertical direction and that of 2.4 mm in the transverse direction.

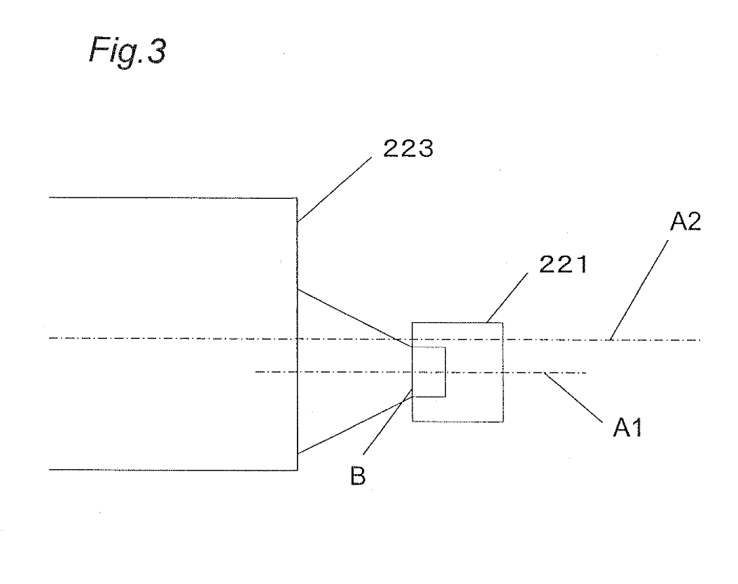

FIG. 3 is a schematic sectional view illustrating the arrangement of the LED element 221 in particular relative to one of the side end surfaces of the light conducting plate 223. The LED element 221 is arranged relatively to the middle surface A2 of the light conducting plate 223 between the front surface and the bottom surface thereof in such a manner that the central axis A1 of the light emitting surface B of the LED element 221 is shifted onto the bottom surface side of the light conducting plate 223, the position of the side being nearer to the reflective sheet 224 than that of the middle surface A2 of the light conducting plate 223. Furthermore, it is preferred that the central axis A1 of the light emitting surface B of the LED element 221 is shifted from the middle surface A2 by ¼ or more of the thickness of the light conducting plate 223.

More specifically, it is more preferred that the LED element 221 is arranged as illustrated in FIG. 3, that is, is arranged relatively to the middle surface A2 of the light conducting plate 223 between the front surface and the bottom surface thereof in such a manner that both end portions of the light emitting surface B of the LED element 221 in the thickness direction of the light conducting plate 223 are included into the bottom surface side of the light conducting plate 223, as well as arranged as above.

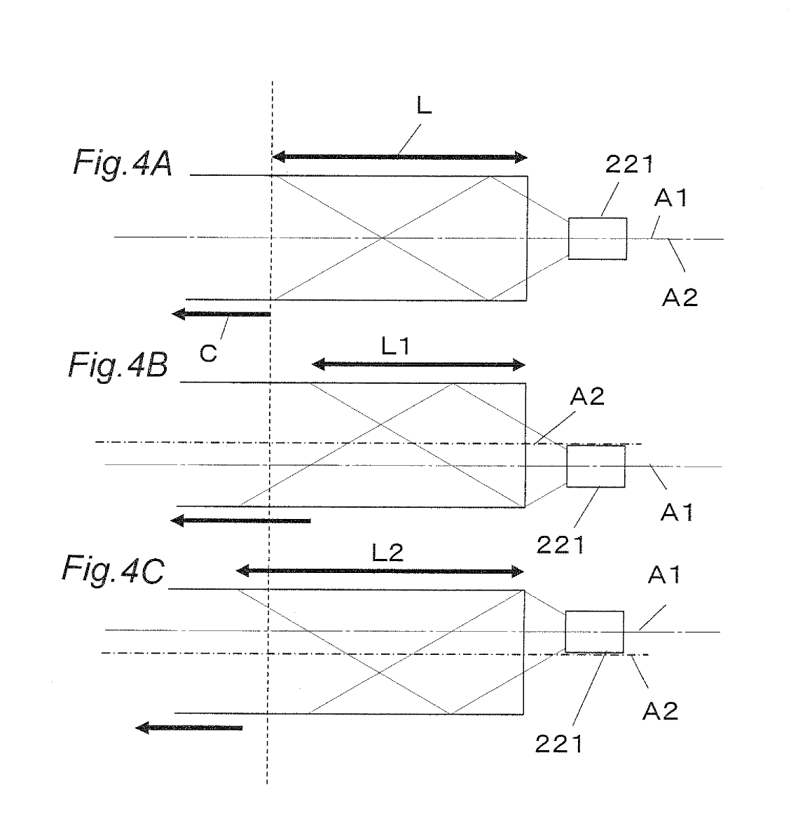

FIG. 4A is a schematic sectional view illustrating the path of light in the light conducting plate 223 when the central axis A1 of the light emitting surface B of the LED element 221 is made consistent with the middle surface A2 between the front surface and the bottom surface of the light conducting plate 223. FIG. 4B is a schematic sectional view illustrating the path of light in the light conducting plate 223 when the central axis A1 of the light emitting surface B of the LED element 221 is shifted from the middle surface A2 onto the bottom surface side. FIG. 4C is a schematic sectional view illustrating the path of light when the central axis A1 of the light emitting surface B of the LED element 221 is shifted from the middle surface A2 onto the front surface side.

As illustrated in FIG. 4A, when the central axis A1 of the light emitting surface B of the LED element 221 is made consistent with the middle surface A2, a reflected light ray reflected on the reflective sheet 224 on the bottom surface is radiated out forward over a distance of L from the end. On the other hand, as illustrated in FIG. 4B, when the central axis A1 of the light emitting surface B of the LED element 221 is shifted onto the bottom surface side, a reflected light ray reflected on the reflective sheet 224 on the bottom surface is radiated out to the front surface side over a distance of L1 from the end. By arranging the LED element 221 onto the bottom surface side in the thickness direction of the light conducting plate 223 as described above, the distance over which a light ray reflected on the reflective sheet 224 on the bottom surface is radiated out from the front surface side can be made short. This makes it possible to shorten the distance over which the end portion of the liquid crystal display unit 210 is covered with the housing 101a on the front surface side. As illustrated in FIG. 4C, when the central axis A1 of the light emitting surface of the LED element 221 is shifted onto the front surface side, a reflected light ray reflected on the reflective sheet 224 on the bottom surface is radiated out to the front surface side over a distance of L2 from the end.

A light ray radiated into the light conducting plate 223 is scattered on the forward-scattering particles 226 while the light ray passes through the light conducting plate 223. However, the light ray is not easily diffused near its end portion where light is to be radiated into the light conducting plate 223, so that the light ray goes straight. Accordingly, as illustrated in FIGS. 4A to 4C, when the light-radiated-out angles from the LED element 221 are equal to each other, distances L, L1 and L2 over which a light ray radiated from the LED element 221 and then radiated into the side end surface of the light conducting plate 223 is reflected on the reflective sheet 224 on the bottom surface and then radiated out from the front surface side of the light conducting plate 223 satisfy the following: L1<L<L2. In other words, when the central axis A of the light emitting surface B of the LED element 221 is shifted onto the bottom surface side that is nearer to the reflective sheet 224 than the middle surface A2 of the light conducting plate 223, the distance over which light is reflected on the reflective sheet 224 on the bottom surface and then radiated out from the front surface side of the light conducting plate 223 can be made shorter.

Accordingly, in the end portion of the light conducting plate 223, the length of an end region H of the light conducting plate 223, which is a region for causing light to be evenly radiated into the liquid crystal display unit 210, can be made short so that the frame region of the image display apparatus 100 can be made small. As a result, the whole of the image display apparatus 100 can be made small.

In this case, it is unnecessary to make the thickness of the light conducting plate 223 small. Therefore, the rigidity of the backlight source unit can be certainly kept so that an image display apparatus having impact resistance and vibration resistance can be realized. Furthermore, as the LED element 221, a smaller LED element can be used; therefore, a large number of LED elements can be arranged for the image display size in the long side direction of the light conducting plate 223 of the image display apparatus 100. For this reason, brightness can be ensured even when an input to each of the LED elements is decreased. In this case, a variable range of an input to each of the LED elements can be made large. Thus, the dynamic range of the brightness thereof can be made wide so that the image display apparatus is usable either indoors or outdoors.

### Second Embodiment

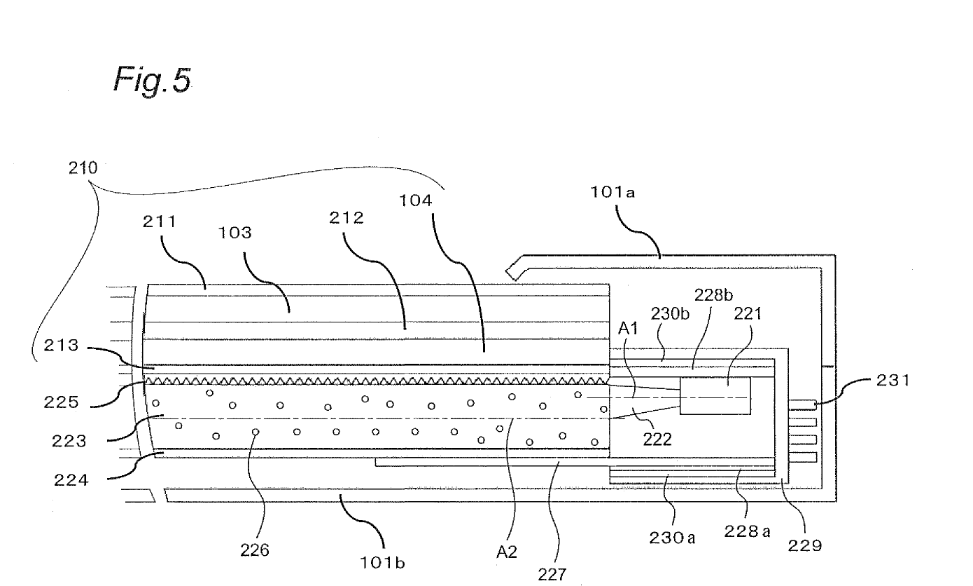

FIG. 5 is a partial sectional view illustrating the structure of a backlight source unit of an image display apparatus according to a second embodiment. The image display apparatus according to the second embodiment has the same basic structure as the image display apparatus 100 described in the first embodiment while the apparatus is different from the first embodiment in LED-arrangement. Specifically, as illustrated in FIG. 4, in the second embodiment, the LED element 221 is arranged relatively to the middle surface A2 between the front surface and the bottom surface of the light conducting plate 223 in such a manner that both end portions of the light emitting surface B of the LED element 221 in the thickness direction of the light conducting plate 223 are included into the front surface side of the light conducting plate 223. This point is different.

In the image display apparatus according to the second embodiment, the LED element 221 is disposed on the front surface side of the light conducting plate 223; thus, the path length over which light is reflected on the reflective sheet 224 on the bottom surface side and then radiated out ahead becomes large. For this reason, light diffusion effect up to the time when light is radiated out ahead after the light is reflected on the reflective sheet 224 becomes large so as to produce an advantageous effect of canceling the so-called bright and dark phenomenon (firefly phenomenon), which is based on a matter that bright regions and dark regions are generated.

### Third Embodiment

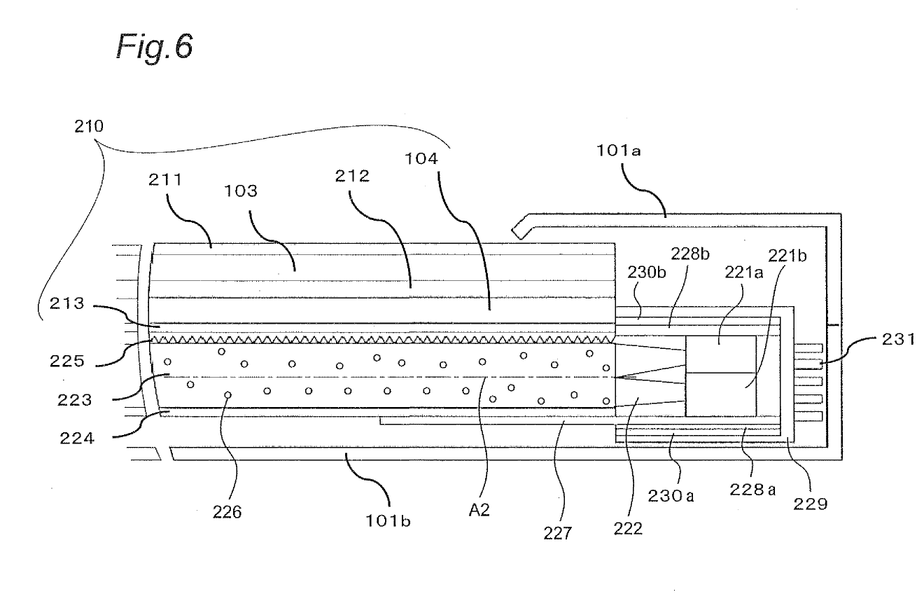

FIG. 6 is a partial sectional view illustrating the structure of a backlight source unit of an image display apparatus according to a third embodiment. The image display apparatus according to the third embodiment has the same basic structure as the image display apparatus 100 described in the first embodiment while the apparatus is different from the first embodiment in LED-arrangement. Specifically, as illustrated in FIG. 6, in the third embodiment, two tiers of an upper LED element 221a and a lower LED element 221b are arranged, as the LED element 221, in the thickness direction of the light conducting plate 223. In this case, the central axis A1 of the light emitting surface B for light-radiation of the upper LED element 221a and the lower LED element 221 b is shifted from the middle surface A2 in the thickness direction of the light conducting plate 223. More specifically, the upper LED element 221a is arranged relatively to the middle surface A2 of the light conducting plate 223 between the front surface and the bottom surface thereof in such a manner that both end portions of the light emitting surface B of the LED element 221a in the thickness direction of the light conducting plate 223 are included in the front surface side of the light conducting plate 223. The lower LED element 221b is arranged relatively to the middle surface A2 of the light conducting plate 223 between the front surface and the bottom surface thereof in such a manner that both end portions of the light emitting surface B of the LED element 221b in the thickness direction of the light conducting plate 223 are included in the bottom surface side of the light conducting plate 223.

Additionally, as illustrated in FIG. 6, in the third embodiment, the lower LED element 221b is jointed to an insulating plate 228 disposed on the same face where the substrate 227 of the reflective sheet 224 laid on the rear surface of the light conducting plate 223 is disposed. The upper LED element 221a is jointed to an insulating plate 228a. These insulating plates 228a and 228b are each jointed to a heat-radiating plate 232 having an opening 240 in a substantially U-shape, more specifically jointed to the opening 240 side of the plate 232, through thermally-conductive double sided adhesive agents 230a and 230b, respectively. The heat-radiating plate 232 is made of metal material good in thermal conductivity, such as aluminum or copper, or the like. In its perpendicular region 232b having a substantially U-shape, heat-radiating fins 234 are formed.

In such a manner, in the third embodiment, the arrangement of the LED element 221 facing one of the end faces of the light conducting plate 223 is rendered an arrangement where two of upper and lower tiers are arranged in the thickness direction of the light conducting plate 223. Therefore, according to the third embodiment, a larger number of LED elements can be arranged to the single light conducting plate 223 than according to conventional embodiments.

Conventionally, for example, 36 LED elements are arranged along each of short sides of a liquid crystal panel having a display size of 10.4 inches, thereby setting the screen brightness to about 250 cd/mm². However, according to the third embodiment, small LED elements giving a high power efficiency are used as LED elements 221, and sixty of the small LED elements can be arranged as upper LED elements 221a and lower LED elements 221b, respectively. In this case, only the upper LED elements 221a or only the lower LED elements 221b make it possible to realize at most a brightness of 1000 cd/mm². The use of the upper LED elements 221a and the lower LED elements 221b at the same time makes it possible to realize at most a brightness of 2000 cd/mm².

Therefore, according to the third embodiment, an image display apparatus giving a very wide dynamic brightness-range can be realized by controlling an input to each of the LED elements 221a and 221b, controlling the upper LED elements 221a and the lower LED elements 221b separately, or controlling these in combination. For this reason, an information processing machine on which such an image display apparatus is mounted can be used freely in accordance with the brightness environment of indoors or the outdoors. Moreover, an information processing machine having a very high versatility and an improved portability can be realized.

In the third embodiment, the substantially U-shaped heat-radiating plate 232 is used as the heat-radiating plate for radiating heat from the LED element 221, and the upper LED elements 221a and the lower LED elements 221b are arranged in the opening 240 in the plate 232. Furthermore, the heat-radiating fins 234 for increasing the area for radiating heat to the outside are formed in the perpendicular region 232b of the heat-radiating plate 232. Thus, heat generated from each of the LED elements can be effectively radiated, and the heat-radiating plate 232 can be formed in one unit to make it possible to heighten the cooling efficiency of each of the LED elements.

### Fourth Embodiment

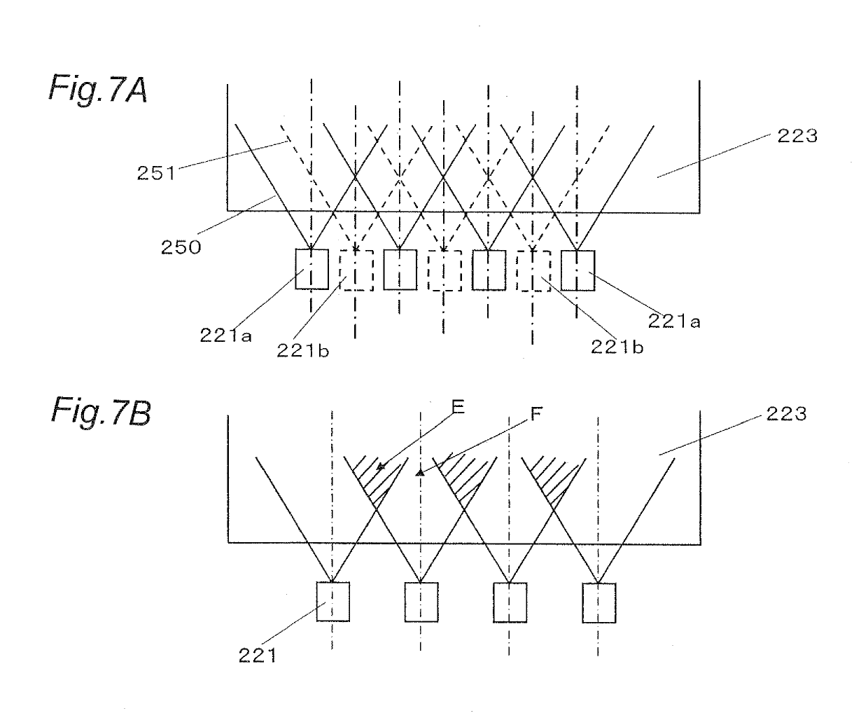

FIG. 7A is a schematic plan view illustrating the arrangement of LED elements 221 of a backlight source of an image display apparatus according to a fourth embodiment. In FIG. 7A, upper LED elements 221a and incident light rays 250 are represented by solid lines, the rays 250 being radiated out from the upper LED elements 221a and then radiated into the light conducting plate 223. On the other hand, lower LED elements 221b and incident light rays 251 are represented by broken lines, the rays 251 being radiated out from the lower LED elements 221b and then radiated into the light conducting plate 223. FIG. 7B is a plan view of a structure wherein LED elements of a backlight source unit of an image display apparatus are arranged on a line in the same plane. As illustrated in FIG. 7A, in the image display apparatus according to the fourth embodiment, the LED elements 221 are arranged in the manner that the upper LED elements 221a and the lower LED elements 221b are alternately arranged when viewed from the thickness direction of the light conducting plate 223. When viewed from one of the side end surfaces of the light conducting plate 223, the upper LED elements 221 a and the lower LED elements 221b are arranged in a zigzag form.

As described in the first embodiment, light radiated into the light conducting plate 223 is scattered by the forward-scattering particles 226 while the light passes through the light conducting plate 223; however, near its end portion where light is to be radiated into the light conducting plate 223, light is not easily diffused so as to go straight. Therefore, in a case where the LED elements 221 are arranged only on a line in the same plane as illustrated in FIG. 7B, near the end portion where light is to be radiated into the light conducting plate 223, there is caused a bright and dark phenomenon (firefly phenomenon) that bright regions E and dark regions F are generated in the distribution of the luminous intensity. In other words, the bright regions E, which are brighter than the other regions, are generated in the regions where light rays from any adjacent ones of the LED elements 221 overlap with each other.

Such a bright and dark phenomenon does not come to be generated in regions apart from the end portion of the light conducting plate 223 by a predetermined distance since light is diffused by the forward-scattering particles 226 arranged in the light conducting plate 223 so as to be dispersed. It is therefore necessary to make the frame region length of the image display apparatus 100 longer by the predetermined distance in order that the regions where the bright and dark phenomenon is generated may not be included in the effective display region of the image display apparatus. If this frame region length is made large, the effective display region unfavorably becomes small accordingly.

On the other hand, as illustrated in FIG. 7A, in the fourth embodiment, the upper LED elements 221a and the lower LED elements 221b are alternately arranged relatively to the plane of the light conducting plate 223. For this reason, the incident light rays 250 from the upper LED elements 221a and the incident light rays 251 from the lower LED elements 221b are overlapped with each other, and further the entire area is turned into a bright state by the light diffusing effect so that the generation of a bright and dark phenomenon (firefly phenomenon) can be restrained.

Accordingly, the bright and dark phenomenon based on the overlap of light rays is cancelled so that an image display apparatus giving an even luminous intensity distribution can be realized and the frame region length of the image display apparatus can also be made short.

The image display apparatus according to the present invention is a long-lifespan and small-sized image display apparatus that gives an adjustable brightness and realizes high brightness, and is useful as a portable image display apparatus for an information processing machine.

The present invention has been described in detail by way of the above-mentioned preferred embodiments; however, the present invention is not limited thereto. It will be obvious to those skilled in the art that many preferred varied embodiments or modified embodiments can be made within a technical scope of the present invention defined in the claims appended in the following.

1. An image display apparatus, comprising:
a liquid crystal display unit having a display surface and rear surface facing a display surface;
a light conducting plate having a front surface, a bottom surface facing the front surface, and a side end surface perpendicular to the front surface and the bottom surface, the light conducting plate being arranged to face the rear surface of the liquid crystal display unit, the front surface of the light conducting plate facing the rear surface of the liquid crystal display unit, wherein the light conducting plate has a reflective sheet on the bottom surface, wherein incident light from a side end surface of the light conducting plate is reflected on the reflective sheet on the bottom surface so as to be conducted toward the front surface; and
an LED element that has a light emitting surface facing the side end surface of the light conducting plate, for radiating light from the light emitting surface to the side end surface,
wherein the LED element is arranged in the manner that the central axis of the light emitting surface of the LED element is shifted onto either of the bottom surface side or the front surface side of the light conducting plate from the middle surface of the light conducting plate, the middle surface being between the front surface and the bottom surface of the light conducting plate.

2. The image display apparatus according to claim 1, wherein the LED element is arranged relatively to the middle surface of the light conducting plate between the front surface and the bottom surface of the light conducting plate in the manner that both end portions of the light emitting surface of the LED element in the thickness direction of the light conducting plate are included into the bottom surface side of the light conducting plate.

3. The image display apparatus according to claim 1, wherein the LED element is arranged relatively to the middle surface of the light conducting plate between the front surface and the bottom surface of the light conducting plate in the manner that both end portions of the light emitting surface of the LED element in the thickness direction of the light conducting plate are included into the front surface side of the light conducting plate.

4. The image display apparatus according to claim 1, wherein the LED element includes:
one or more upper LED elements arranged relatively to the middle surface of the light conducting plate between the front surface and the bottom surface of the light conducting plate in the manner that both end portions of the light emitting surface of the LED element(s) in the thickness direction of the light conducting plate are included into the front surface side of the light conducting plate; and
one or more lower LED elements arranged relatively to the middle surface of the light conducting plate between the front surface and the bottom surface of the light conducting plate in the manner that both the end portions of the light emitting surface of the LED element(s) in the thickness direction of the light conducting plate are included into the bottom surface side of the light conducting plate.

5. The image display apparatus according to claim 4, wherein the upper LED elements and the lower LED elements are alternately arranged when the LEDs are viewed from the thickness direction of the light conducting plate.

6. The image display apparatus according to claim 4, further comprising a heat-radiating plate having an opening region wherein an opening is made toward the side end surface of the light conducting plate,
wherein the upper and lower LEDs are arranged in the opening region of the heat-radiating plate.

7. The image display apparatus according to claim 1, wherein the light conducting plate contains forward-scattering particles arranged to be dispersed.

8. The image display apparatus according to claim 1, wherein a prism sheet is laid between the light conducting plate and the front surface side facing the rear surface of the liquid crystal display unit.

9. The image display apparatus according to claim 5, further comprising a heat-radiating plate having an opening region wherein an opening is made toward the side end surface of the light conducting plate,
wherein the upper and lower LEDs are arranged in the opening region of the heat-radiating plate.
